(19) United States
(12) Patent Application Publication
(10) Pub. No.: US 2025/0368068 A1
(43) Pub. Date: Dec. 4, 2025

(54) CURRENT RIPPLE FREQUENCY PARTITIONING

(71) Applicant: VISTEON GLOBAL TECHNOLOGIES, INC., Van Buren, MI (US)

(72) Inventor: Alan J. Joseph, Shelby Township, MI (US)

(73) Assignee: VISTEON GLOBAL TECHNOLOGIES, INC., Van Buren Township, MI (US)

(21) Appl. No.: 19/223,412

(22) Filed: May 30, 2025

Related U.S. Application Data
(60) Provisional application No. 63/654,002, filed on May 30, 2024.

(51) Int. Cl. B60L 53/22; H02M 1/14; H02M 1/42

(52) U.S. Cl. CPC B60L 53/22; H02M 1/143; H02M 1/42; B60L 2210/10

(57) ABSTRACT

An on-board charger circuit includes a power factor correction circuit, a capacity bank circuit, and a DC-to-DC converter. The power factor correction circuit has an electrical interface and is operational to receive a single-phase electrical power through the electrical interface, and convert the single-phase electrical power to a first DC electrical power. The first DC electrical power has a ripple current. The capacity bank circuit is operational to filter the first DC electrical power. The capacity bank circuit includes a high-frequency filter circuit operational to filter a high frequency component in the ripple current, and a low-frequency filter circuit operational to filter a low frequency component in the ripple current. The DC-to-DC converter is operational to convert the first DC electrical power as filtered to a second DC electrical power, wherein the second DC electrical power has a different voltage than the first DC electrical power.

### CROSS-REFERENCE TO RELATED APPLICATIONS

This application claims the benefit of U.S. Provisional Application No. 63/654,002, filed May 30, 2024, which is hereby incorporated by reference in its entirety.

### TECHNICAL FIELD

The present disclosure generally relates to current frequency ripple partitioning, such as to facilitate DC link volume minimization for single-phase DC rectification circuits and systems.

### BACKGROUND

Currently state of art for on-board chargers in vehicles may size electrolytic capacitors to withstand operating ripple currents produced by a power factor correction circuit and a DC-to-DC converter to ensure a sufficient life in the vehicles under defined operating conditions. However, the electrolytic capacitors can be quite large.

Accordingly, those skilled in the art continue with research and development efforts in the field of reducing a total energy storage size in on-board chargers in vehicles.

### SUMMARY

An on-board charger circuit is provided herein. The on-board charger circuit includes a power factor correction circuit, a capacity bank circuit, and a DC-to-DC converter. The power factor correction circuit has an electrical interface for connecting to an external charging station and is connectable to two conductors. The power factor correction circuit is operational to receive a single-phase electrical power through the electrical interface, and convert the single-phase electrical power to a first DC electrical power on the two conductors. The first DC electrical power has a ripple current. The capacity bank circuit is coupled to the two conductors and is operational to filter the first DC electrical power. The capacity bank circuit includes a high-frequency filter circuit connected between the two conductors and operational to filter a high frequency component in the ripple current, a low-frequency filter circuit connected between the two conductors and operational to filter a low frequency component in the ripple current. The DC-to-DC converter is coupled to the two conductors and is operational to convert the first DC electrical power as filtered to a second DC electrical power. The second DC electrical power has a different voltage than the first DC electrical power.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a schematic diagram of a system in accordance with one or more exemplary embodiments.

FIG. 2 illustrates a schematic block diagram of an on-board charger circuit in accordance with one or more exemplary embodiments.

FIG. 3 illustrates a schematic block diagram of a capacity bank circuit in accordance with one or more exemplary embodiments.

FIG. 4 illustrates graphs of ripple currents for a low-pass filter circuit in accordance with one or more exemplary embodiments.

FIG. 5 illustrates a graph 200 of a ripple current for a high-pass filter circuit in accordance with one or more exemplary embodiments.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a system and/or method for on-board charging that reduces a total size of energy storage in an on-board charger (OBC) circuit by replacing some electrolytic capacitors with smaller film capacitors and a small inductor. For on-vehicle applications, the on-board charger circuit converts alternating-current (AC) electrical power to direct-current (DC) electrical power (e.g., during battery charging) and/or vice-versa when the directionality is reversed (e.g., during vehicle-to-everything (V2X)) electrical power transfers. The battery charging may be Level 1 AC and/or Level 2 AC charging.

In some circumstances where a single phase alternating-current (AC) voltage is rectified to a direct-current (DC) voltage, the resulting input power includes a ripple current at twice the input voltages frequency. To store energy during low points in the ripple, a bank of electrolytic capacitors may be used to smooth the rectified DC voltage. A power factor correction (PFC) circuit is used as an active high-frequency switching circuit that keeps the harmonic content of the source current low, and optionally one that would make the input current purely sinusoidal. As the PFC is a high frequency active circuit, the PFC produces ripple currents into the electrolytic capacitors that have both low frequency (e.g., twice the input voltage frequency) and high frequency. The electrolytic capacitors generally include larger internal resistance than other technologies, such as film capacitors. Therefore, the electrolytic capacitors are suited for filtering low-frequency components of the ripple current. While the electrolytic capacitors are useful for energy storage given a large capacitance per volume, the film capacitors are better at filtering the high-frequency components of the ripple current.

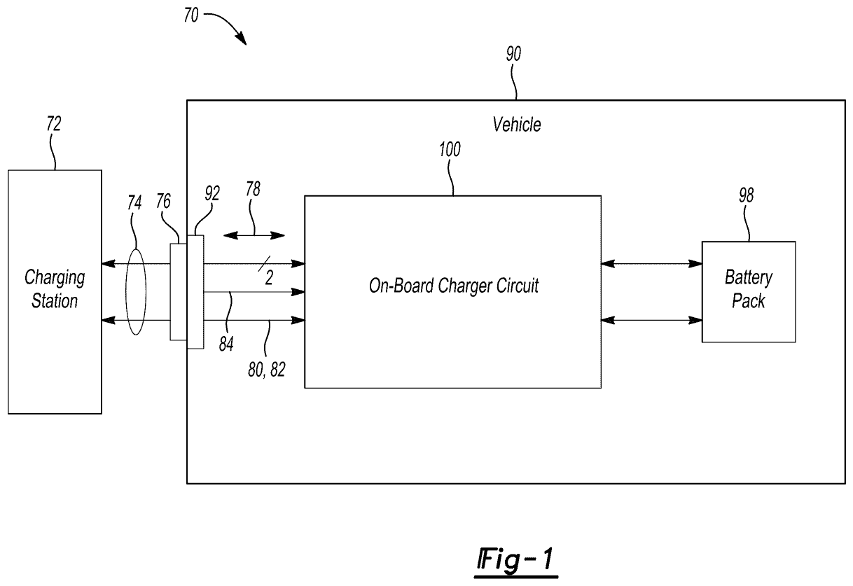

FIG. 1 illustrates a schematic diagram of a system 70 in accordance with one or more exemplary embodiments. The system 70 generally includes a charging station 72 and a vehicle 90. The charging station 72 includes a charging cable 74 and a charging plug 76. The vehicle 90 includes a charging socket 92, a battery pack 98, and an on-board charger circuit 100.

Electrical power 78 may flow between the charging station 72 and the on-board charger circuit 100 in either direction via the charging cable 74, the charging plug 76 and the charging socket 92. The electrical power 78 may be single-phase alternating-current (AC) electrical power.

A control signal 80 may be presented from the charging plug 76, through the charging socket 92 to the on-board charger circuit 100. The control signal 80 may convey one of multiple commands 82 to on-board charger circuit 100. The commands 82 instruct the on-board charger circuit 100 a number of phases in the electrical power 78 and a direction that the electrical power 78 is flowing (e.g., into the on-board charger circuit 100 via the charging socket 92 or out of the charging socket 92 from the on-board charger circuit 100.

A communication signal 84 may be exchanged between the charging station 72 and the on-board charger circuit 100 via the charging cable 74, the charging plug 76, and the charging socket 92. The communication signal 84 may provide standard signaling information between the charging station 72 and the on-board charger circuit 100 to start, control, and stop the flow of the electrical power 78.

The charging station 72 is operational to provide electrical power (e.g., electrical current at a voltage) to the vehicle 90 to recharge onboard batteries of the vehicle 90. In various embodiments, the charging stations 72 may be compliant with the SAE International J1772 standard and/or the International Electrotechnical Commission (IEC) 61851-1 standard. The charging stations 72 may be a Level 1 AC or a Level 2 AC charger. Other charging standards may be implemented to meet the design criteria of a particular application. Some charging stations 72 may be placed at fixed locations. Other charging stations 72 may be mobile.

The charging plug 76 implements an electric charging handle. The charging socket 92 implements a vehicle charging receptacle. The charging plug 76 is connectable and disconnectable from the charging socket 92. The charging plug 76 and the charging socket 92 are operational to transfer the electrical power 78, control signal 80, and the communication signal 84 between the charging station 72 and the vehicle 90.

The vehicle 90 implements an electric-powered vehicle, a hybrid vehicle, or a plug-in hybrid vehicle. In various embodiments, the vehicle 90 may be compliant with the SAE International J1772 standard and/or the International Electrotechnical Commission (IEC) 61851-1 standard. The vehicles 90 may implement Level 1 AC and/or Level 2 AC charging capabilities. Other standards may be implemented to meet the design criteria of a particular application. In various embodiments, the vehicle 90 may include, but is not limited to, a passenger vehicle, a truck, an autonomous vehicle, a motorcycle, a boat, and/or an aircraft. In some embodiments, the vehicles 90 may be a stationary object such as a room, a booth and/or a structure. Other types of vehicles 90 may be implemented to meet the design criteria of a particular application.

The battery pack 98 implements as a high-voltage rechargeable energy storage system. The battery pack 98 is configured to store electrical energy. The battery pack 98 is generally operational to receive electrical power from the on-board charger circuit 100 and provide electrical power to the on-board charger circuit 100. The battery pack 98 may include multiple battery modules electrically connected in series and/or in parallel. In various embodiments, the battery pack 98 may provide approximately 200 to 1000 volts DC (direct current) electrical potential. Other battery voltages may be implemented to meet the design criteria of a particular application.

The on-board charger circuit 100 is operational to accept or alternately provide single-phase AC electrical power (e.g., electrical power 78). While operating in a single-phase input mode, the on-board charger circuit 100 is operational to convert an input single-phase electrical power to a first direct-current (DC) electrical power. The first DC electrical power may be filtered and subsequently converted to a second DC electrical power suitable for charging the battery pack 98. The second DC electrical power has a different voltage than the first DC electrical power. While operating in a single-phase output mode, the on-board charger circuit 100 may receive the second DC electrical power from the battery pack 98, convert the second DC electrical power to the first DC electrical power, and subsequently convert the first DC electrical power to an output single-phase AC electrical power. In various embodiments, the on-board charger circuit 100 may be located in the vehicle 90. In other embodiments, the on-board charger circuit 100 may reside at a fixed location.

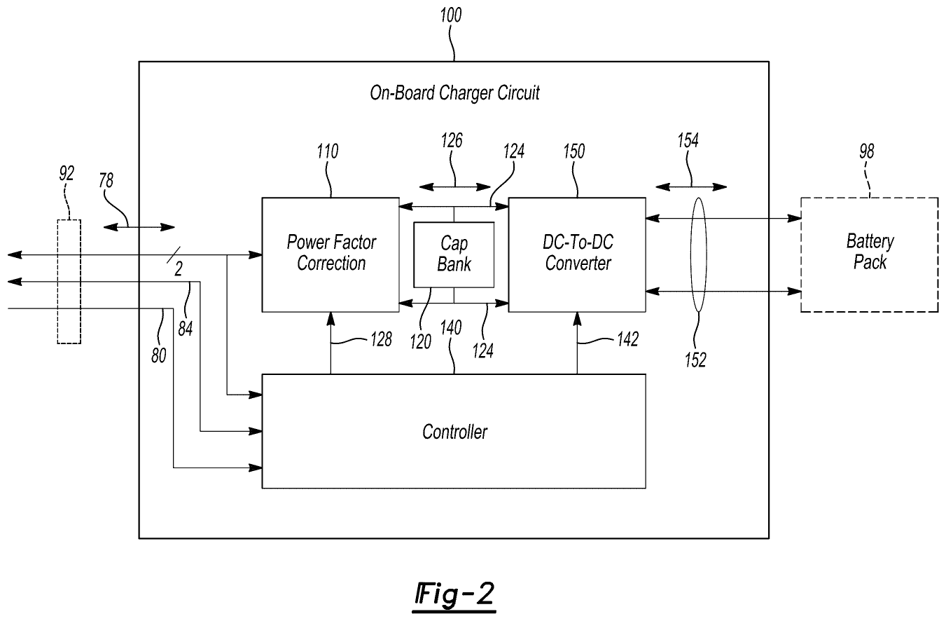

FIG. 2 illustrates a schematic block diagram of an example implementation of the on-board charger circuit 100 in accordance with one or more exemplary embodiments. The on-board charger circuit 100 generally includes a power factor correction circuit 110, a capacity bank circuit 120, a controller 140, and a DC-to-DC converter 150. The power factor correction circuit 110 includes an electrical interface 112 and two conductors 124.

The electrical power 78 is connected to the electrical interface 112 of the power factor correction circuit 110, and to the controller 140. The control signal 80 is received by the controller 140. A switching signal 128 is generated by the controller 140 and is received by the power factor correction circuit 110. The switching signal 128 carries switching information that controls the power factor correction circuit 110. A DC conversion signal 142 is generated by the controller 140 and presented to the DC-to-DC converter 150. The DC conversion signal 142 conveys more switching information that controls the DC-to-DC converter 150.

The power factor correction circuit 110 is operational in a single-phase input mode to convert single-phase AC electrical power 78 received at the electrical interface 112 to the first DC electrical power 126 on the two conductors 124 as controlled by the switching signal 128. The power factor correction circuit 110 is operational in a single-phase output mode to convert the first DC electrical power 126 received via the two conductors 124 into single-phase AC electrical power 78 presented at the electrical interface 112 as controlled by the switching signal 128.

The capacity bank circuit 120 implements a dual-band filter circuit coupled to the power factor correction circuit 110. The capacity bank circuit 120 includes a high-frequency filter circuit operational to filter a high frequency component (e.g., >approximately 1000 hertz) in the ripple current and a low-frequency filter circuit operational to filter a low frequency component (e.g., <approximately 1000 hertz) in the ripple current. The high-frequency filter circuit and the low-frequency filter circuit are directly connected between the two conductors 124 and in parallel with each other.

The controller 140 implements one or more processors executing software. The software may be stored in non-transitory computer readable media (e.g., nonvolatile memory). The software, when executed by the processors, may cause the processors to generate the switching signal 128 and the DC conversion signal 142. Generation of the switching signal 128 and the DC conversion signal 142 is based on the voltage and phase of the electrical power signal 78, the commands 82 in the control signal 80, and the information in the communication signal 84.

The DC-to-DC converter 150 implements a unidirectional and/or a bidirectional converter of DC electrical power coupled to the capacity bank circuit 120. Operations of the DC-to-DC converter 150 are governed by the controller 140 via the DC conversion signal 142. In a charging mode of operation, the DC-to-DC converter 150 converts a filtered version of the first DC electrical power 126 received on the two conductors 124 to second DC electrical power 154 presented at a DC electrical interface 152. In a discharging mode of operation, the DC-to-DC converter 150 converts the second DC electrical power 154 received at the DC electrical interface 152 to the first DC electrical power 126 on the two conductors 124. The second DC electrical power 154 generally has a different (e.g., higher) voltage (e.g., 800 volts) than the first DC electrical power 126 (e.g., 200 volts).

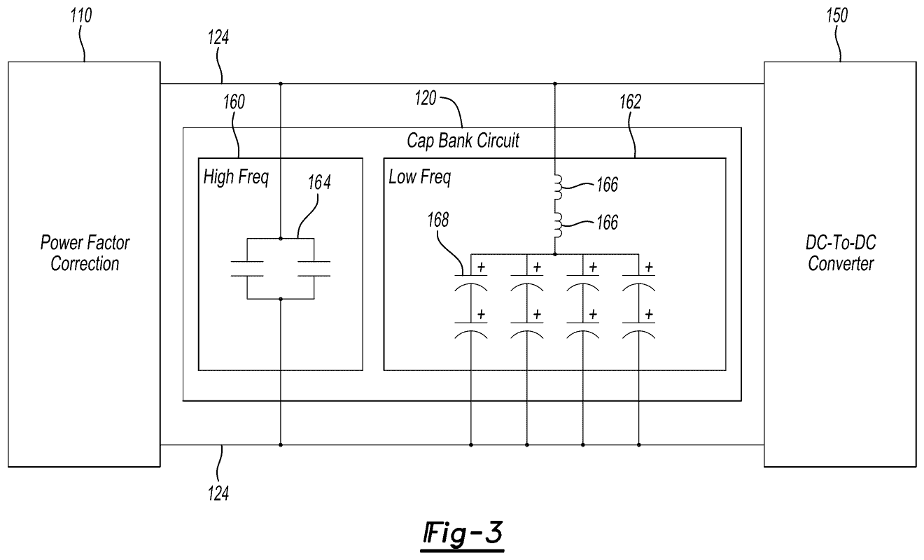

FIG. 3 illustrates a schematic block diagram of an example implementation of the capacity bank circuit 120 in accordance with one or more exemplary embodiments. The capacity bank circuit 120 generally includes a high-frequency filter circuit 160 and a low-frequency filter circuit 162.

The high-frequency filter circuit 160 is connected to the two conductors 124 between the power factor correction circuit 110 and the DC-to-DC converter 150. The high-frequency filter circuit 160 is typically implemented with multiple (e.g., two) film capacitors 164 (e.g., approximately 20 microfarads to approximately 30 microfarads total). The film capacitors 164 may be sized to absorb high-frequency components in the ripple current in the kilohertz to the hundreds of kilohertz range.

The low-frequency filter circuit 162 is connected to the two conductors 124 between the power factor correction circuit 110 and the DC-to-DC converter 150. The low-frequency filter circuit 162 is typically implemented with one or a few (e.g., two) inductors 166 and multiple (e.g., two to eight) electrolytic capacitors 168. The inductors 166 may be wired in series with a total inductance of approximately 4 microhenries. The electrolytic capacitors 168 may be wired in parallel and/or series to form a capacitance of approximately 1000 microfarads.

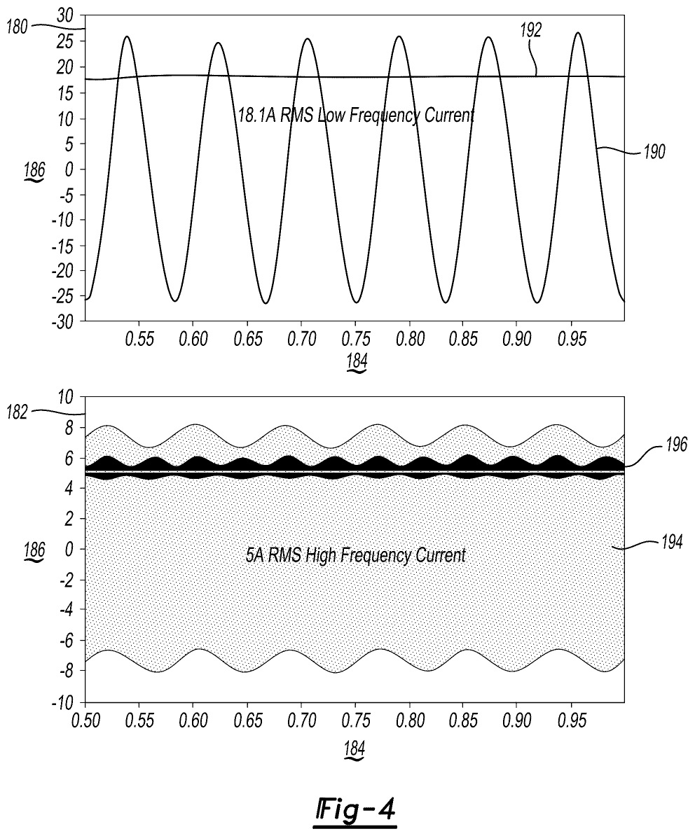

FIG. 4 illustrates graphs 180 and 182 of example ripple currents for the low-pass filter circuit 162 in accordance with one or more exemplary embodiments. The graph 180 illustrates a low-frequency current produced by the low-frequency filter circuit 162. The graph 182 illustrates a high-frequency current produced by the low-frequency filter circuit 162. Each graph 180 and 182 has an X-axis 182 in units of time, and a Y-axis 186 in units of current.

A curve 190 illustrates the low-frequency current generated by the power factor correction circuit 110 upon converting the electrical power signal 78 from AC to DC. A curve 192 illustrates the low-frequency root mean square (RMS) current passing through the low-pass filter circuit 162. The low-frequency RMS current is shown as approximately 18.1 amperes RMS in the example.

A curve 194 illustrates the high-frequency current generated by the power factor correction circuit 110. A curve 196 illustrates the high-frequency root mean square (RMS) current passing through the low-pass filter circuit 162. The high-frequency RMS current is shown as approximately 5 amperes RMS in the example.

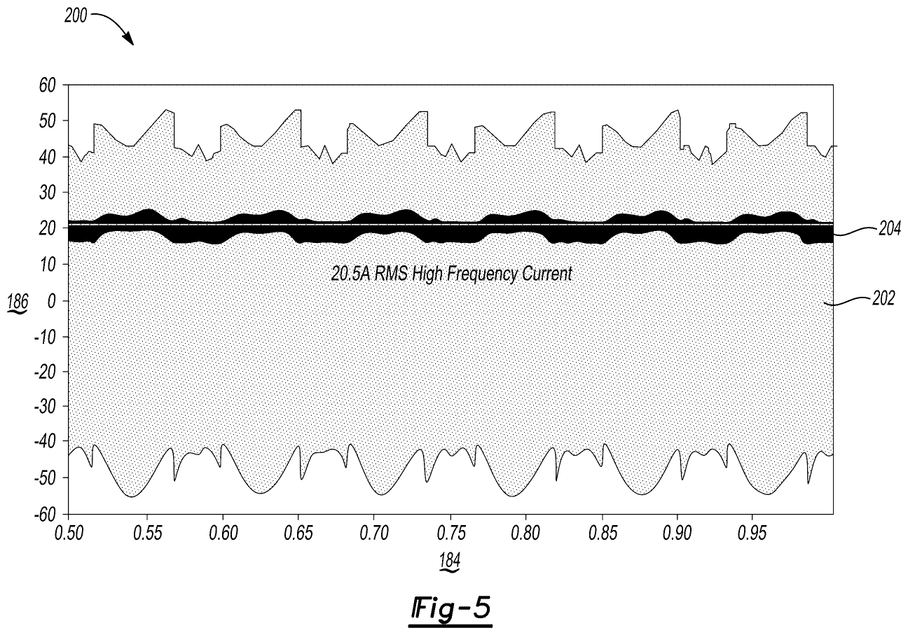

FIG. 5 illustrates a graph 200 of an example ripple current for the high-pass filter circuit 160 in accordance with one or more exemplary embodiments. The graph 200 illustrates a high-frequency current produced by the high-frequency filter circuit 160. The graph 200 has the X-axis 182 in units of time, and the Y-axis 186 in units of current.

A curve 202 illustrates the high-frequency current generated by the power factor correction circuit 110. A curve 204 illustrates the high-frequency root mean square (RMS) current passing through the high-pass filter circuit 160. The high-frequency RMS current is shown as approximately 20.5 amperes RMS in the example. The high-frequency current curve 204 is larger through the high-pass filter circuit 160 compared with the high-frequency current curve 196 and thus provides for better high-frequency filtering.

Implementation of the dual-band filter circuits may enable a number of electrolytic capacitors to be reduced (e.g., from 12 to 8 capacitors, −30% capacitors). Therefore, a size of a circuit board used to mount the capacitors may be reduced from approximately 115 millimeter (mm) by 165 mm (e.g., 16 electrolytic capacitors) to approximately 140 mm by 115 mm (e.g., a 22% size reduction).

The electrolytic capacitors have a relatively higher capacitance per volume than the film capacitors, but also have a higher internal resistance. Therefore, the electrolytic capacitors are suitable for energy storage and lower currents. The film capacitors have a relatively lower capacitance per volume than the electrolytic capacitors, but have a lower internal resistance. Therefore, the film capacitors are suitable for high frequencies and high currents.

One aspect of the present disclosure relates to partitioning the low-frequency current and high-frequency current according to the type of capacitor for which they are best suited, such as between electrolytic, film, and/or other types of capacitors, filters, etc. The capability may be beneficial in matching current frequency to capacitance, optionally in a manner that reduces capacitor and/or other component volume.

The present disclosure may size electrolytic capacitors, and optionally the connected DCDC converter inside an on-board charger circuit to withstand the operating ripple current produced by a power factor correction circuit so as to ensure that the capacitors last a life of a vehicle under defined operating conditions. As electrolytic capacitors can be quite large, one aspect of the present disclosure may be to reduce the total size of the energy storage by replacing some electrolytic capacitors with smaller film capacitors, and optionally to include a relatively small inductor.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. An on-board charger circuit comprising:
a power factor correction circuit having an electrical interface and operational to:
receive a single-phase electrical power through the electrical interface; and
convert the single-phase electrical power to a first DC electrical power on two conductors, wherein the first DC electrical power has a ripple current;
a capacity bank circuit coupled to the two conductors and operational to filter the first DC electrical power, wherein the capacity bank circuit includes:
a high-frequency filter circuit connected between the two conductors and operational to filter a high frequency component in the ripple current; and
a low-frequency filter circuit connected between the two conductors and operational to filter a low frequency component in the ripple current; and
a DC-to-DC converter coupled to the two conductors and operational to convert the first DC electrical power as filtered to a second DC electrical power, wherein the second DC electrical power has a different voltage than the first DC electrical power.

2. A method for on-board charging comprising:
receiving a single-phase electrical power through an electrical interface of an on-board charger circuit;
converting the single-phase electrical power in a power factor correction circuit to a first DC electrical power on two conductors, wherein the first DC electrical power has a ripple current;
filtering a high frequency component in the ripple current with a high-frequency filter circuit connected between the two conductors;
filtering a low frequency component in the ripple current with a low-frequency filter circuit connected between the two conductors; and
converting the first DC electrical power as filtered in a DC-to-DC converter to a second DC electrical power, wherein the second DC electrical power has a different voltage than the first DC electrical power.

3. A vehicle comprising:
a power factor correction circuit having an electrical interface and operational to:
receive a single-phase electrical power through the electrical interface; and
convert the single-phase electrical power to a first DC electrical power on two conductors, wherein the first DC electrical power has a ripple current;
a capacity bank circuit coupled to the two conductors and operational to filter the first DC electrical power, wherein the capacity bank circuit includes:
a high-frequency filter circuit connected between the two conductors and operational to filter a high frequency component in the ripple current; and
a low-frequency filter circuit connected between the two conductors and operational to filter a low frequency component in the ripple current;
a DC-to-DC converter coupled to the two conductors and operational to convert the first DC electrical power as filtered to a second DC electrical power, wherein the second DC electrical power has a different voltage than the first DC electrical power; and
a battery pack coupled to the DC-to-DC converter and operational to be charged by the second DC electrical power.

4. The on-board charger circuit according to claim 1, wherein the high-frequency component is above 1000 hertz.

5. The on-board charger circuit according to claim 1, wherein the high-frequency filter circuit includes a plurality of film capacitors connected in parallel.

6. The on-board charger circuit according to claim 1, wherein the low-frequency component is below 1000 hertz.

7. The on-board charger circuit according to claim 1, wherein the low-frequency filter circuit includes a plurality of electrolytic capacitors.

8. The on-board charger circuit according to claim 7, wherein the plurality of electrolytic capacitors are wired in as a plurality of series capacitors.

9. The on-board charger circuit according to claim 8, wherein the plurality of series capacitors are wired in parallel as a first capacitor.

10. The on-board charger circuit according to claim 9, wherein the low-frequency filter circuit includes a first inductor connected in series with the first capacitor.

11. The on-board charger circuit according to claim 10, wherein the low-frequency filter circuit includes a second inductor connected in series with the first inductor.

12. The method according to claim 2, wherein the high-frequency component is greater than 1000 hertz.

13. The method according to claim 2, wherein the high-frequency filter circuit includes a plurality of film capacitors connected in parallel.

14. The method according to claim 2, wherein the low-frequency component is less than 1000 hertz.

15. The method according to claim 2, wherein the low-frequency filter circuit includes a plurality of electrolytic capacitors.

16. The method according to claim 15, wherein the plurality of electrolytic capacitors are wired in as a plurality of series capacitors.

17. The method according to claim 16, wherein the plurality of series capacitors are wired in parallel as a first capacitor.

18. The method according to claim 17, wherein the low-frequency filter circuit includes a first inductor connected in series with the first capacitor.

19. The method according to claim 18, wherein the low-frequency filter circuit includes a second inductor connected in series with the first inductor.

20. The vehicle according to claim 3, further comprising:
a controller connected to the power factor correction circuit and operational to present a switching signal to the power factor correction circuit based on a voltage of the single-phase electrical power.
